(19) United States
(12) Patent Application Publication
(10) Pub. No.: US 2025/0306239 A1
(43) Pub. Date: Oct. 2, 2025

(54) SYSTEMS AND METHODS FOR PETROPHYSICAL MEASUREMENT MODELING

(71) Applicant: Schlumberger Technology Corporation, Sugar Land, TX (US)

(72) Inventors: Simone Di Santo, Dhahran (SA); Muhanned Alsaif, Dhahran (SA)

(21) Appl. No.: 19/094,173

(22) Filed: Mar. 28, 2025

Related U.S. Application Data
(60) Provisional application No. 63/571,135, filed on Mar. 28, 2024.

(51) Int. Cl. G01V 20/00

(52) U.S. Cl. CPC G01V 20/00

(57) ABSTRACT

A method includes: generating a synthetic geological formation model, including: receiving relative dip angles, determining a dielectric assumption, a horizontal relative permittivity, a vertical relative permittivity, and a vertical resistivity, and determining respective apparent dielectric permittivity and resistivity, performing 1D inversion, including: generating random geological layer parameters, generating a reference formation model, forward modeling the synthetic geological formation model, generating attenuation and phase-shift logs, generating a 1D inversion model, and generating inverted resistivity and inverted permittivity (EPSI), training a dielectric enhancement model, including: validating the dielectric enhancement model with the apparent dielectric permittivity and resistivity and an enhanced EPSI, training a convolutional neural network (CNN) with the inverted resistivity and permittivity and the relative dip angle, and updating the enhanced EPSI, generating a model prediction for a target geological formation, including: receiving logged values for the target geological formation, and correcting the logged values with the trained dielectric enhancement model.

### CROSS-REFERENCE TO RELATED APPLICATION(S)

This application is a claims priority to and the benefit of U.S. Provisional Patent Application No. 63/571,135, filed on Mar. 28, 2024, the entire disclosure of which is incorporated herein for all purposes.

### TECHNICAL FIELD

This disclosure generally relates to systems and methods for petrophysical measurement modeling.

### BACKGROUND

High frequency dielectric data (e.g., about 10 MHz and up into GHz ranges) have been routinely used to estimate formation water-filled porosity. A one-dimensional (1D) inversion algorithm was developed for single coil propagation tools to obtain relative dielectric constant and resistivity of a single layer with a relative dip angle. Later and with the introduction of a robust forward modeling, it was possible to test the capability of a dielectric constant 1D inversion algorithm at very high relative dip angles (e.g., sub-horizontal wells) starting from a synthetic geological formation model. Later results confirmed the potential application of the 1D inversion to very high dip relative angles, e.g., beyond 75°. Results showed that, starting from 75°, with the relative dip approaching 89° relative dip angle, 1D inverted relative permittivity gradually loses its capability of distinguishing between layers by progressively showing spikes and polarization horns, even with favorable conditions, especially when anisotropy is present. Thus, logging while drilling (LWD) propagation tool dielectric inversion artifacts that make inverted logs are generally not usable for geological formation prediction purposes.

Another main factor affecting the dielectric constant results was the in-phase (σᵣ) and quadrature (σₓ) signals. A low ratio between real and apparent components of the currents (σᵣ/σₓ<10) was found to be a fundamental condition for the applicability of the 1D inversion, especially for anisotropic scenarios.

The 1D inverted resistivity, however, was found to be much more robust and tolerant to the high angle and anisotropy. Spikes, polarization horns and noise start to appear only at 85° progressively increasing with anisotropy, but layers were rarely obliterated even at the border condition of 85° relative angle and anisotropy of 5.

Accordingly, there is a need for systems and methods to enhance the propagation tool inverted dielectric. There is also a need to reduce or eliminate the polarization horns, spikes, and aberrations occurring in highly deviated and horizontal wells.

### SUMMARY

This disclosure pertains to systems and methods for petrophysical measurement modeling.

A first aspect of this disclosure pertains to a method, including: generating a synthetic geological formation model of a synthetic geological formation, including: receiving values for: layer thicknesses for each layer of the synthetic geological formation, resistivity contrast for each layer of the synthetic geological formation, horizontal resistivity, resistivity anisotropy, and relative dip angle, determining a dielectric assumption, determining a horizontal relative permittivity based on the dielectric assumption and the resistivity anisotropy, determining a vertical relative permittivity based on the resistivity anisotropy, determining a vertical resistivity based on the horizontal resistivity, and determining, for each layer of the synthetic geological formation, a respective apparent dielectric permittivity value and a respective apparent resistivity value based on the horizontal resistivity, the horizontal relative permittivity, the vertical relative permittivity, and the vertical resistivity, performing one-dimensional (1D) inversion for resistivity and permittivity, including: generating random geological layer parameters based on a statistical distribution, generating a final reference formation model by inputting the random geological layer parameters to the synthetic geological formation model, performing forward modeling of the synthetic geological formation model, generating attenuation and phase-shift logs from the forward modeling, generating a 1D inversion model from the attenuation and phase-shift logs, and generating an inverted resistivity value and an inverted permittivity value, training a dielectric enhancement model, including: validating the dielectric enhancement model with the apparent dielectric permittivity values and the apparent resistivity values of the synthetic geological formation model and an enhanced inverted permittivity value, training a convolutional neural network with the inverted resistivity value, the inverted permittivity value, and the relative dip angle, and updating the enhanced inverted permittivity value with an output of the convolutional neural network when the validating the dielectric enhancement model fails, generating a model prediction for layers of a target geological formation, including: inputting the inverted resistivity value, the inverted permittivity value, and the relative dip angle to the trained and validated dielectric enhancement model to further update the enhanced inverted permittivity value, and identifying respective layers of a target geological formation, including: receiving logged values for the target geological formation including at least: layer thicknesses for each layer of the target geological formation, resistivity contrast for each layer of the target geological formation, horizontal resistivity, resistivity anisotropy, and relative dip angle, and correcting the logged values for the target geological formation by inputting the logged values into the trained dielectric enhancement model and outputting corrected petrophysical parameters for the target geological formation.

A second aspect of this disclosure pertains to the method of the first aspect, wherein the convolutional neural network includes: an input layer, a plurality of repeating hidden layer sets, each of the plurality of repeating hidden layer sets including: a normalization layer, a convolutional layer, and a rectified linear unit, and an output layer.

A third aspect of this disclosure pertains to the method of the second aspect, wherein the plurality of repeating hidden layer sets is repeated 5 times.

A fourth aspect of this disclosure pertains to the method of the first aspect, wherein: the values for: layer thicknesses for each layer of the synthetic geological formation, resistivity contrast for each layer of the synthetic geological formation, horizontal resistivity, resistivity anisotropy, and relative dip angle are provided as an input matrix, the input matrix is split into a plurality of sub-matrices and input into the convolutional neural network, and an output of the convolutional neural network is scaled and split into training and validation datasets.

A fifth aspect of this disclosure pertains to the method of the first aspect, and further includes predicting a bulk volume of water (BVW) for the target geological formation, including: receiving neutron porosity and gamma ray values for the target geological formation, and correcting the logged values and the neutron porosity and gamma ray values for the target geological formation with the trained dielectric enhancement model and outputting the BVW for the target geological formation.

A sixth aspect of this disclosure pertains to the method of the first aspect, and further includes performing a blind test on a known model layer sequence to evaluate the model prediction.

A seventh aspect of this disclosure pertains to the method of the first aspect, and further includes displaying a comparison of the corrected logged values and the received logged values.

An eighth aspect of this disclosure pertains to the method of the first aspect, wherein: the corrected petrophysical parameters include a corrected dielectric permittivity value, and the method further includes: measuring a dielectric permittivity value for a target geological formation with a downhole tool operating in the target geological formation, comparing the measured dielectric permittivity value to the corrected dielectric permittivity value, determining that the downhole tool is not on a target path based on a result of the comparing, and changing a path of the downhole tool to match the target path.

A ninth aspect of this disclosure pertains to a system, including: one or more processors, and a non-transitory computer-readable medium storing instructions that, when executed, cause the one or more processors to: generate a synthetic geological formation model of a synthetic geological formation, including: receiving values for: layer thicknesses for each layer of the synthetic geological formation, resistivity contrast for each layer of the synthetic geological formation, horizontal resistivity, resistivity anisotropy, and relative dip angle, determining a dielectric assumption, determining a horizontal relative permittivity based on the dielectric assumption and the resistivity anisotropy, determining a vertical relative permittivity based on the resistivity anisotropy, determining a vertical resistivity based on the horizontal resistivity, and determining, for each layer of the synthetic geological formation, a respective apparent dielectric permittivity value and a respective apparent resistivity value based on the horizontal resistivity, the horizontal relative permittivity, the vertical relative permittivity, and the vertical resistivity, perform one-dimensional (1D) inversion for resistivity and permittivity, including: generating random geological layer parameters based on a statistical distribution, generating a final reference formation model by inputting the random geological layer parameters to the synthetic geological formation model, performing forward modeling of the synthetic geological formation model, generating attenuation and phase-shift logs from the forward modeling, generating a 1D inversion model from the attenuation and phase-shift logs, and generate an inverted resistivity value and an inverted permittivity value, train a dielectric enhancement model, including: validating the dielectric enhancement model with the apparent dielectric permittivity values and the apparent resistivity values of the synthetic geological formation model and an enhanced inverted permittivity value, training a convolutional neural network with the inverted resistivity value, the inverted permittivity value, and the relative dip angle, and updating the enhanced inverted permittivity value with an output of the convolutional neural network when the validating the dielectric enhancement model fails, generate a model prediction for layers of a target geological formation, including: inputting the inverted resistivity value, the inverted permittivity value, and the relative dip angle to the trained and validated dielectric enhancement model to further update the enhanced inverted permittivity value, and identify respective layers of a target geological formation, including: receiving logged values for the target geological formation including at least: layer thicknesses for each layer of the target geological formation, resistivity contrast for each layer of the target geological formation, horizontal resistivity, resistivity anisotropy, and relative dip angle, and correcting the logged values for the target geological formation by inputting the logged values into the trained dielectric enhancement model and outputting corrected petrophysical parameters for the target geological formation.

A tenth aspect of this disclosure pertains to the system of the ninth aspect, wherein the convolutional neural network includes: an input layer, a plurality of repeating hidden layer sets, each of the plurality of repeating hidden layer sets including: a normalization layer, a convolutional layer, and a rectified linear unit, and an output layer.

An eleventh aspect of this disclosure pertains to the system of the tenth aspect, wherein the plurality of repeating hidden layer sets is repeated 5 times.

A twelfth aspect of this disclosure pertains to the system of the ninth aspect, wherein: the values for: layer thicknesses for each layer of the synthetic geological formation, resistivity contrast for each layer of the synthetic geological formation, horizontal resistivity, resistivity anisotropy, and relative dip angle are provided as an input matrix, the input matrix is split into a plurality of sub-matrices and input into the convolutional neural network, and an output of the convolutional neural network is scaled and split into training and validation datasets.

A thirteenth aspect of this disclosure pertains to the system of the ninth aspect, wherein the instructions further cause the one or more processors to predict a bulk volume of water (BVW) for the target geological formation, including: receiving neutron porosity and gamma ray values for the target geological formation, and correcting the logged values and the neutron porosity and gamma ray values for the target geological formation with the trained dielectric enhancement model and outputting the BVW for the target geological formation.

A fourteenth aspect of this disclosure pertains to the system of the ninth aspect, wherein the instructions further cause the one or more processors to perform a blind test on a known model layer sequence to evaluate the model prediction.

A fifteenth aspect of this disclosure pertains to the system of the ninth aspect, wherein the instructions further cause the one or more processors to display a comparison of the corrected logged values and the received logged values.

A sixteenth aspect of this disclosure pertains to the system of the ninth aspect, wherein: the corrected petrophysical parameters include a corrected dielectric permittivity value, and the instructions further cause the one or more processors to: measure a dielectric permittivity value for a target geological formation with a downhole tool operating in the target geological formation, compare the measured dielectric permittivity value to the corrected dielectric permittivity value, determine that the downhole tool is not on a target path based on a result of the comparing, and change a path of the downhole tool to match the target path.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a flowchart of an example workflow of a dielectric enhancement model according to an example embodiment of the present disclosure.

FIG. 2 is a flowchart of a workflow for computing apparent dielectric permittivity (ε_{r,a}) and apparent resistivity (Rₐ) at each layer of a formation model.

FIG. 3 is a set of graphs of experimental results showing statistical distributions of a layer of a model according to an example embodiment of the present disclosure.

FIG. 4 is a set of graphs for an example of a generated synthetic geological formation model.

FIG. 5 is an example of a workflow for a temporal convolution network (TCN) architecture.

FIG. 6 is set of experimental results from an enhancement model for a propagation tool inverted dielectric constant.

FIGS. 7A-7F are graphs of experimental results from a blind test using an Oklahoma model layer sequence.

FIG. 8 is an example of a workflow for bulk volume of water prediction.

FIG. 9 is a set of cross-sectional views of a geological formation.

FIG. 10 is an example of a general workflow for database generation and model training.

FIG. 11 is an example of a workflow for model application.

FIG. 12 is a graph of layer thickness probability distribution.

FIG. 13 is a graph of resistivity contrast probability distribution.

FIG. 14 is a flowchart of a geological formation model generation process according to an example embodiment of the present disclosure.

FIG. 15 is a cross section of a geological formation with a well and tool and measurements and parameters for the geological formation.

FIG. 16 illustrates certain components that may be included within a computer system according to an example embodiment of the present disclosure.

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, there are shown in the drawings and will be described in detail herein specific embodiments with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, like reference numerals refer to like elements.

Example embodiments of the present disclosure may enhance the propagation tool inverted dielectric, and may reduce or eliminate the polarization horns, spikes, and aberrations occurring in highly deviated and horizontal wells. Example embodiments may provide a machine learning-based process that may improve the accuracy of a one-dimensional (1D) inverted dielectric constant at extreme high angles and anisotropy. In addition, example embodiments may create a machine learning (ML) model to predict a bulk volume of water (BVW) in fresh and mixed water environments by using the enhanced inverted dielectric constant and other petrophysics logs.

Example embodiments may improve and enhance the inverted dielectric constant (“EPSI”) for high relative dip angles (“DPAPs”). Moreover, example embodiments may use the EPSI to develop a machine learning model to predict a total BVW in a mixed salinity real-world scenario.

The EPSI for high DPAPs may be improved and enhanced by leveraging on the forward and 1D inversion models for single coil propagation tool to create an ML supervised model that, by learning from an initial formation model, may be able to totally or partially remove inverted dielectric spikes, polarization horns, and other aberrations occurring in extreme logging geometries. The enhanced dielectric constant may be used as main input along with other selected logs for a supervised ML BVW prediction model that is blind-tested.

### I. Dielectric 1D Inversion Enhancement Model

A supervised dielectric enhancement model may be trained using an initial synthetic geological formation model. The dielectric enhancement model may take, as input, the synthetic geological formation model Apparent Dip Angle (DPAP) and the 1D inverted relative permittivity and resistivity to output the enhanced dielectric constant.

The development of the Dielectric Enhancement Model may be divided into 5 phases:
1. Synthetic geological formation model Generation at different relative dip angles and anisotropy.
2. Reference Formation forward modeling to obtain the propagation attenuation and propagation (AT/PS) logs.
3. Resistivity and Relative Permittivity 1D Inversion.
4. Dielectric Enhancement Model training using initial synthetic geological formation model layers as labels.
5. Dielectric Enhancement Model prediction.

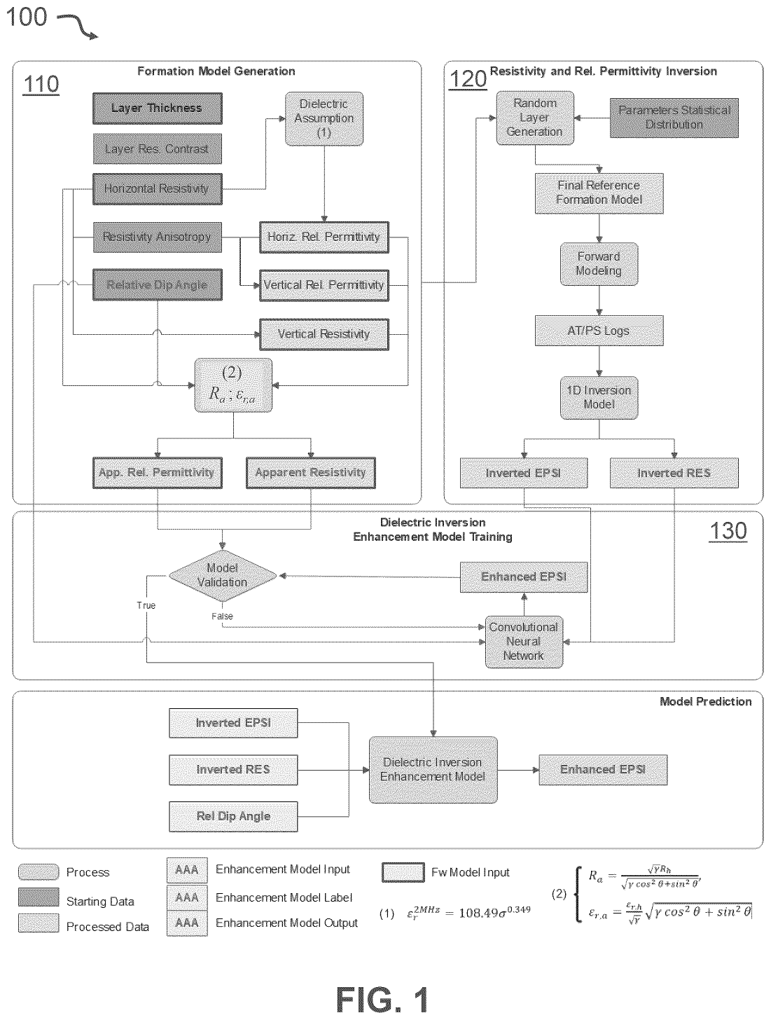

FIG. 1 is a flowchart of an example workflow of a dielectric enhancement model according to an example embodiment of the present disclosure.

FIG. 1 illustrates a detailed example workflow 100 of a dielectric enhancement model. The illustrated example dielectric enhancement model is based on a 1D convolutional neural network algorithm. After training with a proper label database, the model can recognize the inverted EPSI output polarization horns, spikes, and aberrations, and may correlate them to an original synthetic geological formation model layer sequence. This correlation may enable the model to correct the EPSI inverted curve for the combination of the apparent EPSI and DPAP.

The example dielectric enhancement model workflow 100 may include generating a reference synthetic geological formation model (upper-left section 110); random layer generation and resistivity (“RES”) and EPSI 1D inversion (upper-right section 120); dielectric enhancement model training (130) using synthetic geological formation model computed apparent EPSI and RES as labels; and a model prediction (140). The model prediction 140 may include, for example, a blind test on a known model layer sequence, e.g., on an Oklahoma model layer sequence, to evaluate the results.

Once a validation test shows adequate results and the model is well-fit, training may stop. The synthetic geological formation model may be at the core of the performance of the trained model. The synthetic geological formation model may be generated, for example, by an algorithm that may calculate random layer parameters while still maintaining predefined statistical distributions.

Some advantages of the workflow 100 include:
Dielectric enhancement model leverage on the forward/inversion modeling capability;
Able to correct EPSI inverted extreme artifacts;
Random geological layer parameters may be restricted within certain statistical range;
The model can learn from the initial geological formation model layers; and
Once there are enough random layers there may be no need for a model update.

### A. Formation Model Generation

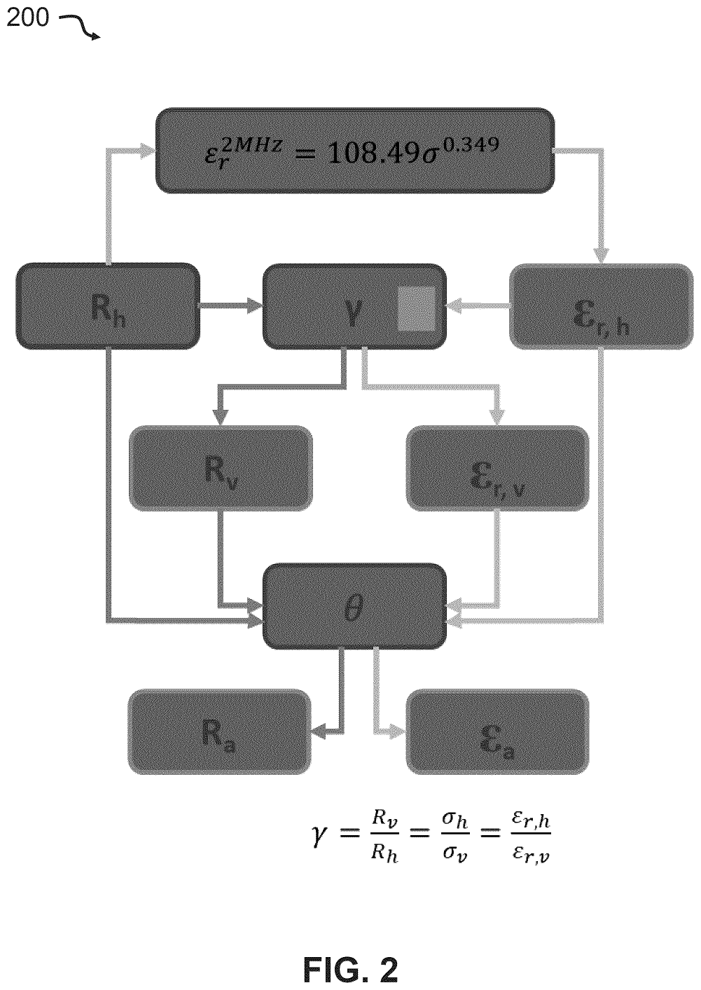

FIG. 2 is a flowchart of a workflow for computing apparent dielectric permittivity (ε_{r,a}) and apparent resistivity (Rₐ) at each layer of a formation model.

To enable a good learning of the dielectric enhancement, model the initial synthetic geological formation model is generated while enforcing predefined statistical distributions. The task is performed by an ad-hoc algorithm that automatically produce the forward model input files.

Formation model apparent resistivity and dielectric permittivity may be generated starting from horizontal resistivity, for example, according to the following four steps:
1. Conductivity and dielectric constant share the same anisotropy.
2. Layer relative permittivity is calculated by applying the dielectric assumption for 2 MHz single coil propagation tools starting from horizontal resistivity.
3. Layer vertical relative permittivity and vertical resistivity are computed by applying the selected anisotropy value.
4. Layer apparent dielectric permittivity and apparent resistivity are computed by using the vertical and horizontal component and the relative dip angle.

The apparent dielectric permittivity (ε_{r,a}) and apparent resistivity (Rₐ) calculations are described below in the section titled “III. Apparent Conductivity and Dielectric Constant for Coaxial Propagation Measurements.”

In the FIG. 2 example, an example workflow 200 is illustrated for computing apparent dielectric permittivity (ε_{r,a}) and apparent resistivity (Rₐ) at each layer of the formation model. In the FIG. 2 example, Rₕ, γ, θ, and

$${ε}_{r}^{2 MHz} = 108.49 {σ}^{0.349}$$

are given data, and ε_{r,h}, Rᵥ, ε_{r,v}, Rₐ, and εₐ are computed data.

A formation model may be prepared starting from a wide range of resistivities, anisotropies and relative dip angles to produce enough labels and build a robust model. Inversion curve cleaning may drastically improve the inversion field of application. The formation model may be prepared, for example, from 70° to 89° apparent formation angle and with resistivity anisotropy up to 10. Table 1 lists the value ranges produced by experimental results using formation models in accordance with example embodiments of the present disclosure. A total of 504 random parameter layers for four geographic formations were generated. The formation model may preserve the true stratigraphic thickness along the relative angle increase.

Table 1 shows a range of formation model parameters that may be used for labelling. For example, 200 layers with resistivity/dielectric values for each layer may be arranged to produce a good range of resistivity inter-layer contrast.

TABLE 1

| Parameter | From | To | Step | Total |
|---|---|---|---|---|
| Apparent | 70° | 89° | 1° | 19 |
| Formation Angle | | | | |
| Resistivity Anisotropy | 1 | 10 | 1 | 10 |
| Layer Thickness | 1 ft | 5 ft | 1 | 5 |
| Layer Resistivity | 0.2 Ohm · m | 2000 Ohm · m | Various | 200 |

Given the 1D inversion model computes dielectric and resistivity from logs along a deviated well, the formation model layers are seen by their apparent thickness projected on the well borehole. A total of fifty cases were generated in an experiment based on a combination of relative dip angles (e.g., 10 values) and resistivity anisotropy (e.g., 5 values) for four random synthetic formations. Each synthetic geological formation model layer may be defined from horizontal resistivity and layer true stratigraphic thickness (TST).

An experiment using random synthetic formation generation was performed by limiting the parameters spreading in their limits and distribution. Table 2 lists the parameters used for the synthetic model generation. The four generated formations' (total of 570 layers) apparent RES and EPSI values were computed for each of the 10 Apparent Dip Angles (65°, 70°, 73°, 78°, 80°, 82°, 84°, 86°, 88°, 89°), and at 5 different resistivity anisotropy values (1, isotropic, 2, 3, 4 and 5), which gives a total of 28,500 layers available for the training. Theoretically, increasing the number of layers the Dielectric Enhancement Model should improve its performance. The particular numbers given above are by way of example for the purposes of the experiment, and are not intended to be limiting.

TABLE 2

| Parameter | Value |
|---|---|
| Formations | 4 |
| Total layers | 570 |
| Total Depth (ft.) | 3304 |
| Min thickness | 1 |
| Max thickness | 20 |
| Min Resistivity (Ω · m) | 0.2 |
| Max Resistivity (Ω · m) | 2000 |
| Apparent Dip Angle (°) | 65, 70, 73, 78, 80, 82, 84, 86, 88, 89 |
| Anisotropy | 1, 2, 3, 4, 5 |

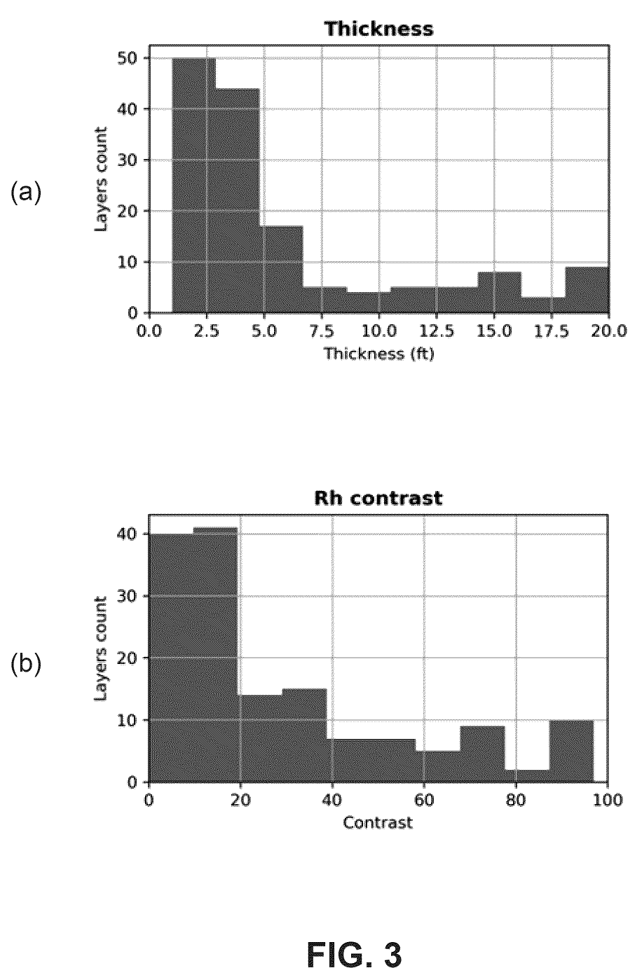

FIG. 3 is a set of graphs of experimental results showing statistical distributions of a layer of a model according to an example embodiment of the present disclosure.

FIG. 3 illustrates experimental results showing a statistical distribution of the layer TST and resistivity inter-layer contrast of the initial 570 layers before applying the tangential function to calculate the Relative Dip Angle. The experimental workflow attempted generate as many combinations of layers as possible to produce the highest possible numbers of curve aberrations related to layer geometry and electromagnetic properties.

FIG. 3 shows a statistical distribution of the layer TST in part (a) and a statistical distribution of a resistivity inter-layer contrast Rₕ in part (b) of the initial 570 layers before applying the tangential function to calculate the relative dip angle. Most of the values shown in the experimental results reside below 5 feet (ft.) for layer thickness (TST) and below 20 ft. for horizontal resistivity inter-layer contrast.

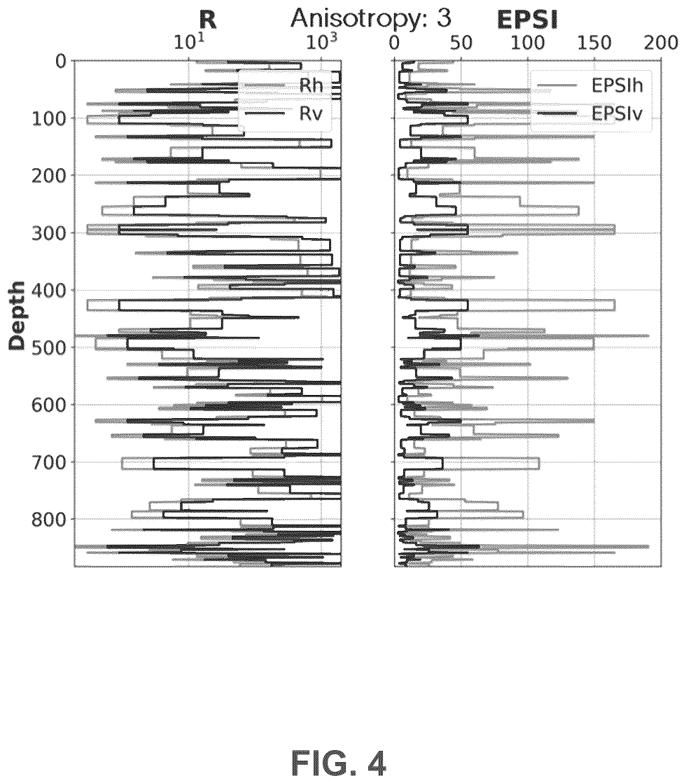

FIG. 4 is a set of graphs for an example of a generated synthetic geological formation model.

FIG. 4 shows an example of one of the generated synthetic geological formation models used in an experiment before rotation and apparent dielectric permittivity and apparent resistivity computation. In FIG. 4, an example is illustrated of one of the generated synthetic geological formation models before rotation and apparent dielectric permittivity and apparent resistivity computation. A resistivity track is shown on the left graph “R”. A dielectric constant track is shown on the right graph “EPSI”. In the illustrated example, the resistivity anisotropy was set to be equal to 3. The “Rh” and “EPSIh” lines represent a horizontal component, and the “Rv” and “EPSIv” lines represent a vertical component.

### B. Forward Modeling and 1D inversion

The forward modeling may be performed on the final synthetic formation. An attenuation and phase-shift curve set (AT/PS) may be eventually collected as input for the 1D inversion, along with the relative dip angle (DPAP). In one example, only 2 MHz related logs may be used in the inversion as a highest frequency for the single coil propagation tools modeled in the inversion code, which may be more relevant to water volume fracture. The 1D inversion may then generate the apparent resistivity and relative permittivity, as in 120 of FIG. 1.

### C. Dielectric 1D inversion Enhancement Model

Temporal convolution network (TCN) is a useful neural network architecture for the prediction of sequences, such as well logs. A TCN model was developed to predict missing sonic and bulk density logs from gamma ray logs and other drilling information. To correct the relative permittivity logs (EPSI) and remove any alterations, a TCN may be designed and implemented with one dimensional (1D) convolution filters. The developed TCN may be further optimized to find an optimum network architecture. This may be achieved by utilizing the rich and diverse synthetic well logs, as described above, of four different random geological formations. The logs may include five different assumed anisotropy, e.g., 1 to 5, and ten different relative dip angles, e.g., ranging from 65° to 89°, for example, to simulate normal and extreme logging conditions. Based on previous settings, a total of 200 well logging cases were used in experiments used for the optimization and fitting of the TCN with a random 80:20 data split for training/validation. The designed network architecture may intake relative permittivity and resistivity logs, along with the relative dip angle, as inputs then may predict the enhanced relative permittivity log. Additionally, the logs may be pre-processed, e.g., before they are fed to the TCN, which may include scaling and segmentation to help capturing the logs features.

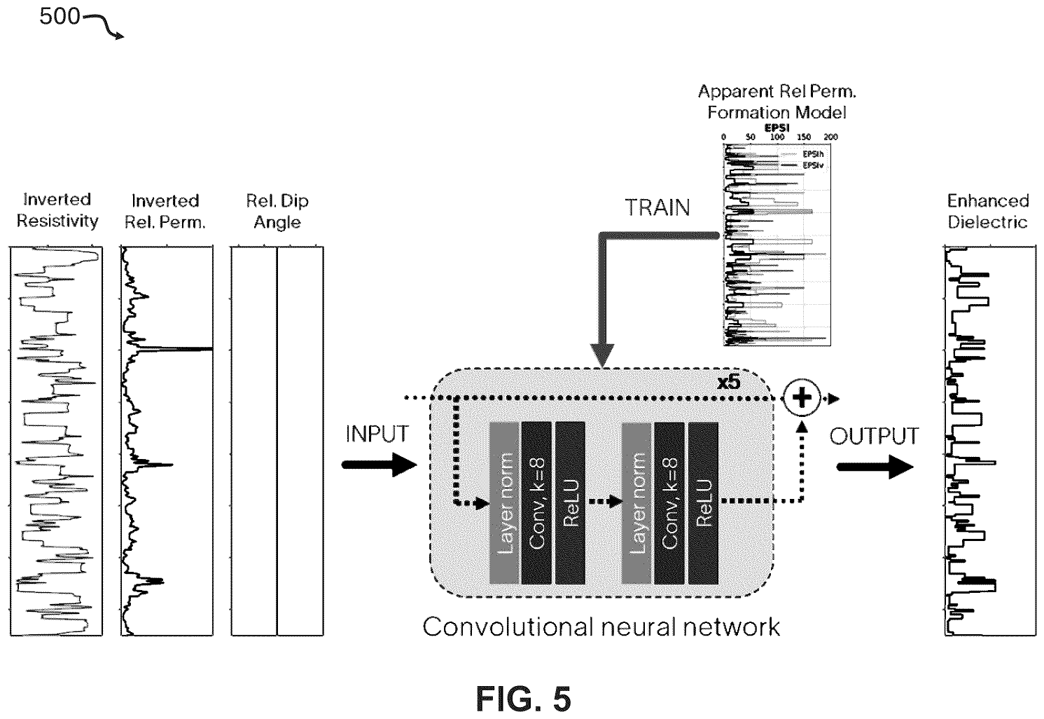

FIG. 5 is an example of a workflow for a temporal convolution network (TCN) architecture.

In FIG. 5, a detailed workflow 500 illustrates how data may be used and results calculated during the model training and testing. A designed temporal convolution network (TCN) architecture may intakes relative permittivity and resistivity logs, along with a relative dip angle, as inputs, and may then predict an enhanced relative permittivity log. The example of FIG. 5 illustrates a convoluted neural network scheme used for an inverted dielectric constant enhancement in an example embodiment.

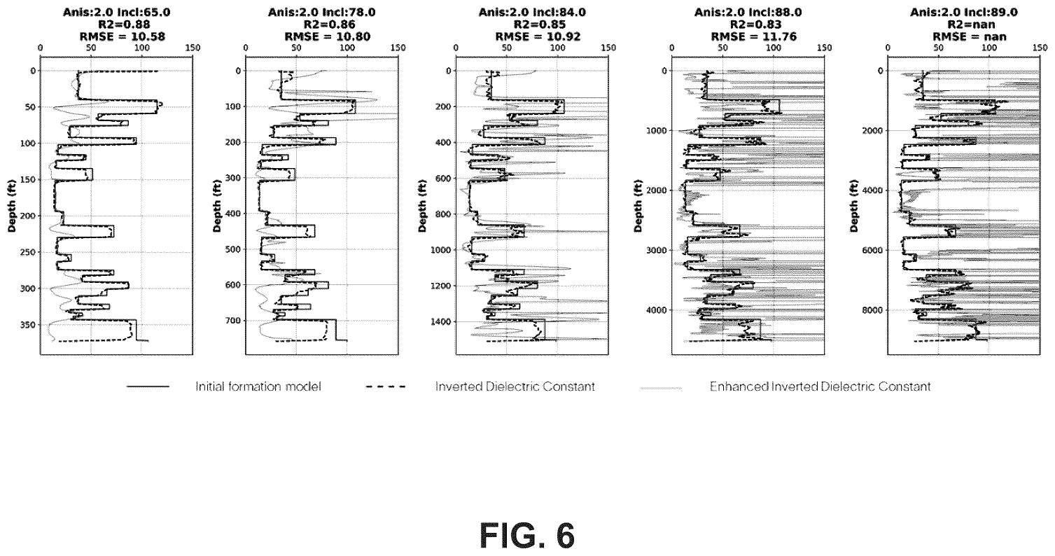

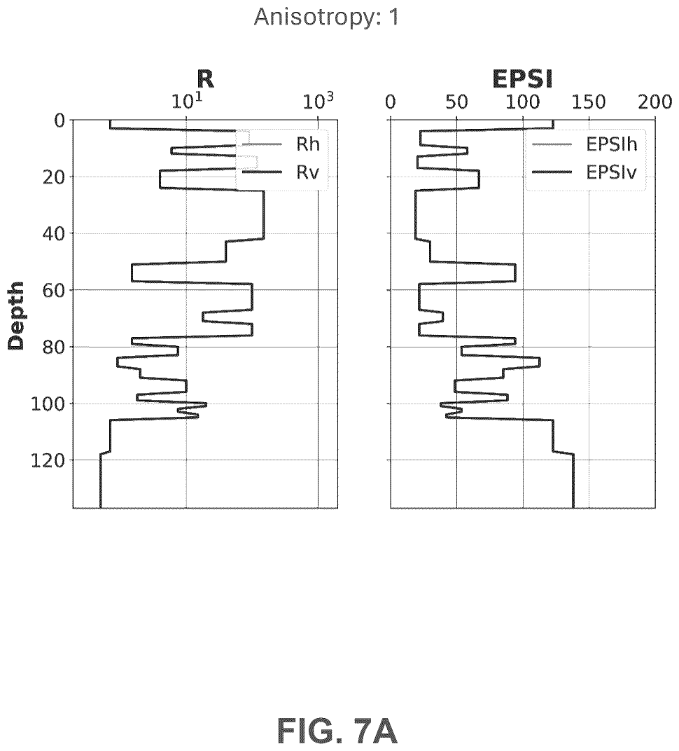

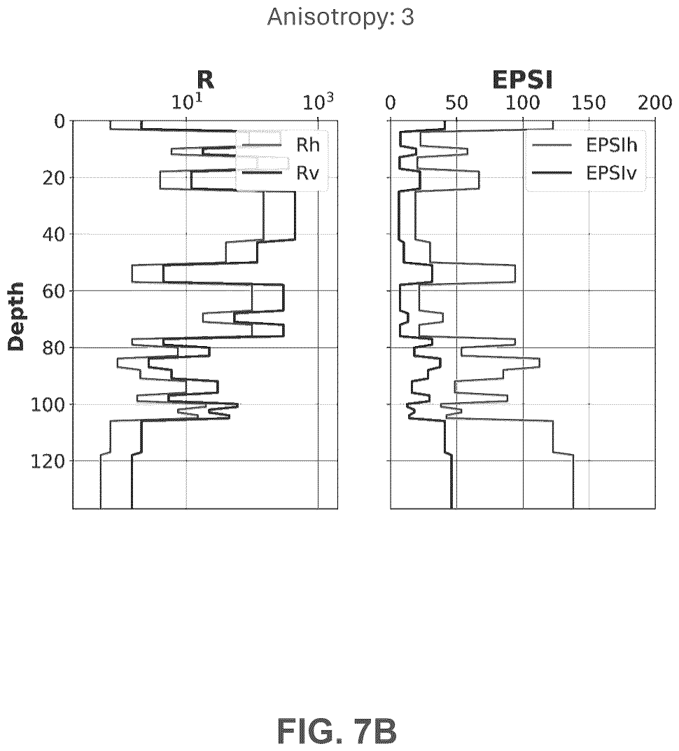

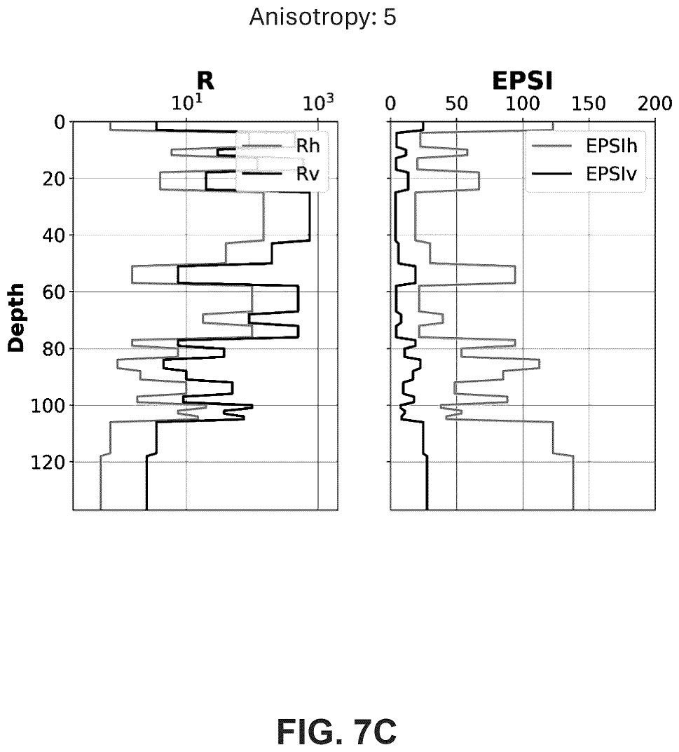

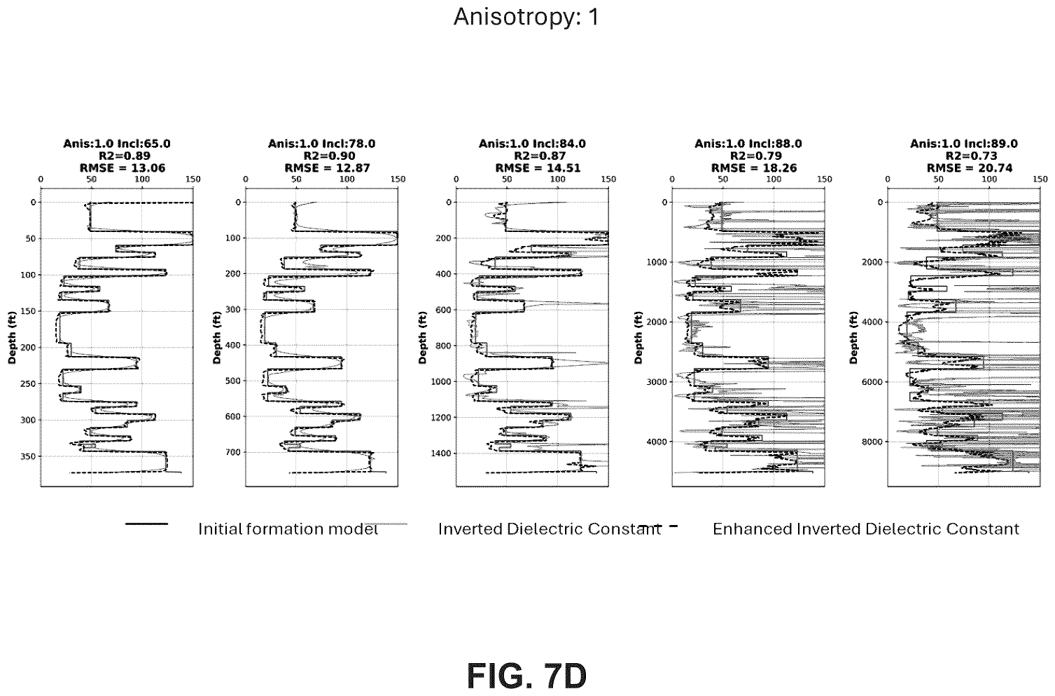

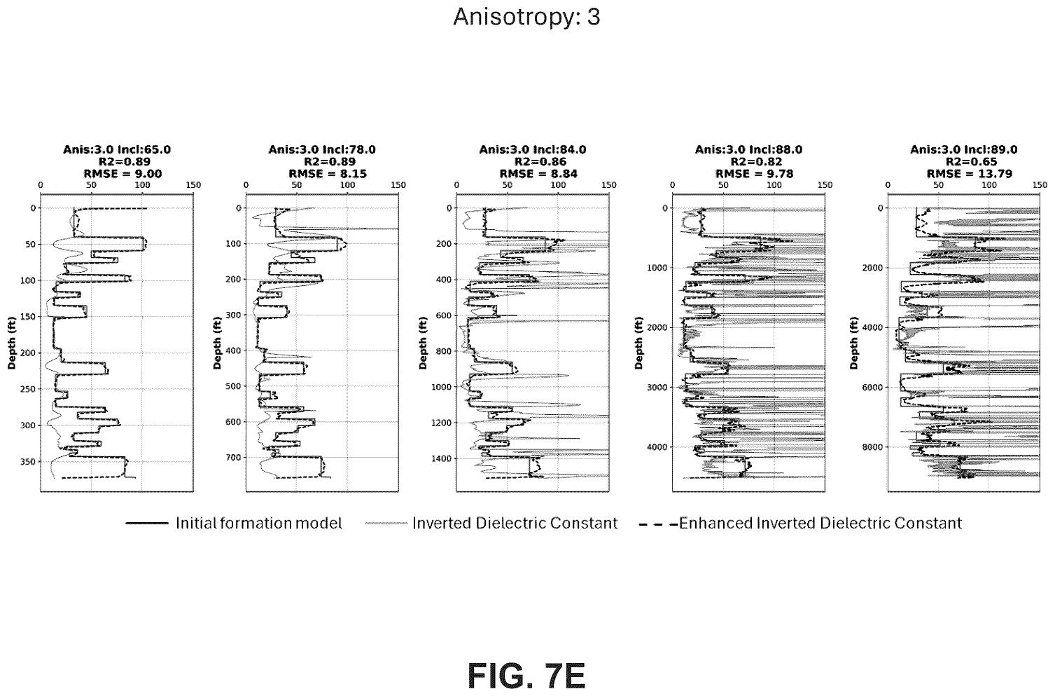

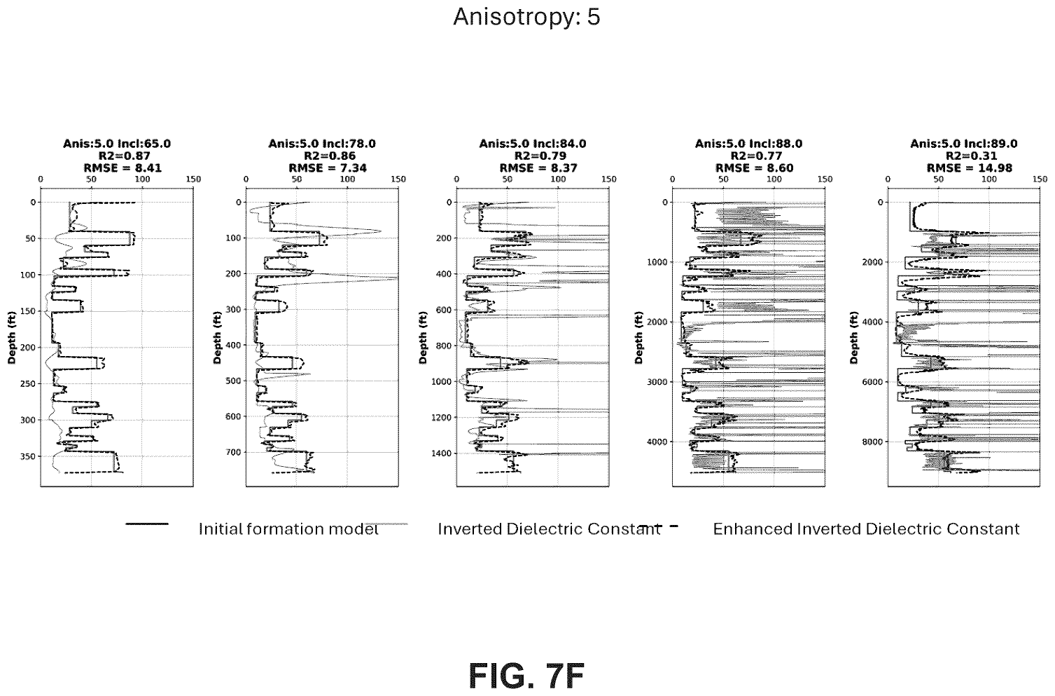

FIG. 6 is set of experimental results from an enhancement model for a propagation tool inverted dielectric constant. FIGS. 7A-7C are graphs of experimental results from a blind test using an Oklahoma model layer sequence.

In FIG. 6, examples of experimental results are shown that were obtained using an Oklahoma model layer sequence at different high relative angles with resistivity anisotropy set to be equal to 2. FIG. 6 shows experimental examples of the enhancement model on a propagation tool inverted dielectric constant. The layers in the Oklahoma model are still very well depicted even at an 89° relative dip angle.

A Relative permittivity 1D inversion enhancement model blind test was performed on the Oklahoma Model layer set. The target layer sequence was not present in the training dataset, and the apparent relative permittivity from the inversion was plotted versus the relative permittivity enhanced after the model. Ten relative dip angles were processed from 65° to 89° versus five resistivity anisotropy values, from 1 (isotropic case) to 5. FIGS. 7A-7F show some of the experimental results, e.g., with anisotropy set to 1, 3, and 5, respectively. Each “Rh” and “EPSIh” line represents a horizontal component, and each “Rv” and “EPSIv” line represents a vertical component.

### II. Bulk Volume of Water Prediction

### A. Water Volume Prediction General Workflow

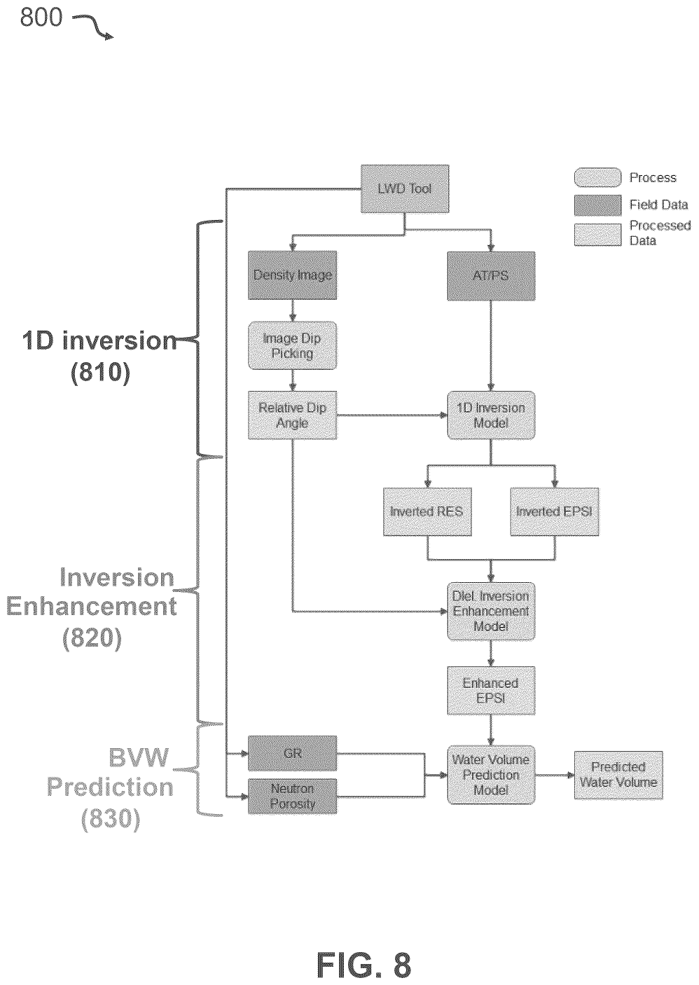

FIG. 8 is an example of a workflow for bulk volume of water prediction.

Bulk volume of water (BVW) prediction model may be generated and assessed, for example, in a real-world scenario, using a high confidence petrophysical interpreted bulk volume of water as a reference. FIG. 8 illustrates an example of a general workflow 800 for bulk volume of water prediction. The process may be divided into three main operations, as shown in FIG. 8:
1. 1D Inversion using AT/PS logs and relative dip angles (810).
2. 1D inversion enhancement applying the Dielectric 1D inversion Enhancement Model (820).
3. Bulk volume of water (BVW) prediction (830).

The BVW prediction model may be trained, for example, using a real-world scenario after propagation phase shift and attenuation logs are inverted and enhanced. To achieve the inputs of the 1D inversion and dielectric enhancement model, formation dips may be interpreted from a Logging While Drilling (LWD) borehole image in phase one.

The first two operations 810, 820 are necessary to prepare an enhanced 1D inverted dielectric permittivity to serve as main input for the BVW prediction model for the third operation 830. The BVW prediction model may also receive neutron porosity and gamma ray logs for the target geological formation as inputs. The interpretation of the formation dips from an LWD image is important to compute the relative dip angle between the well and the formation.

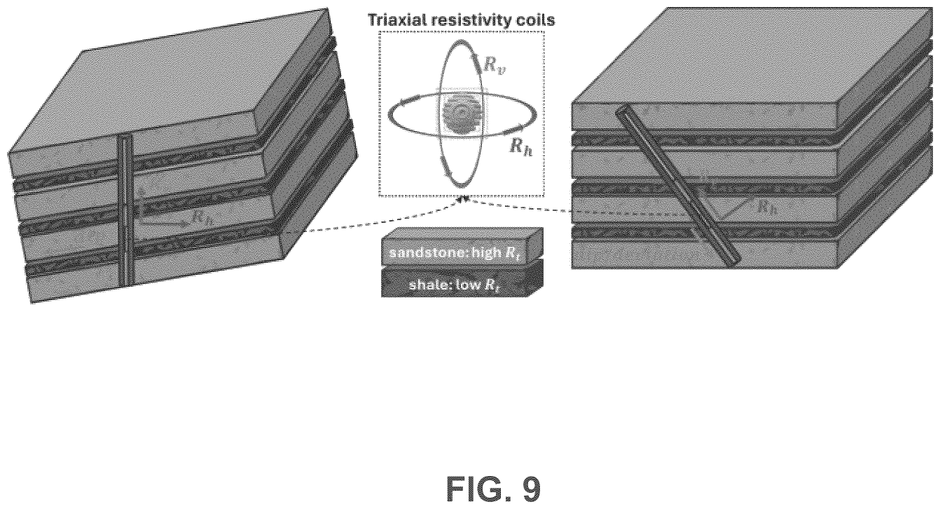

FIG. 9 is a set of cross-sectional views of a geological formation.

Petrophysical Parameters can include anisotropy, which means that the same type of measurement may be different if measured in different directions. This can happen, for example, when the matter has a strongly oriented physical characteristic. For example, in thin-layered formations the current may move more easily when pushed parallel to the layers than when pushed perpendicular to the layers. There may be a difference between vertical (e.g., parallel to a drilling/logging tool) and horizontal (e.g., perpendicular to the tool and/or parallel to the ground surface) resistivity. FIG. 9 shows an example of a geological formation having sandstone with a high true resistivity (Rₜ) and shale having a low Rt. Some logging technologies (e.g., triaxial resistivity induction tools) can perform directional measurements, which may be perpendicular or parallel to the tool. When measuring an anisotropic formation with a tool that has no capability of directional measurement, an observed resistivity may be referred to as “apparent resistivity.”

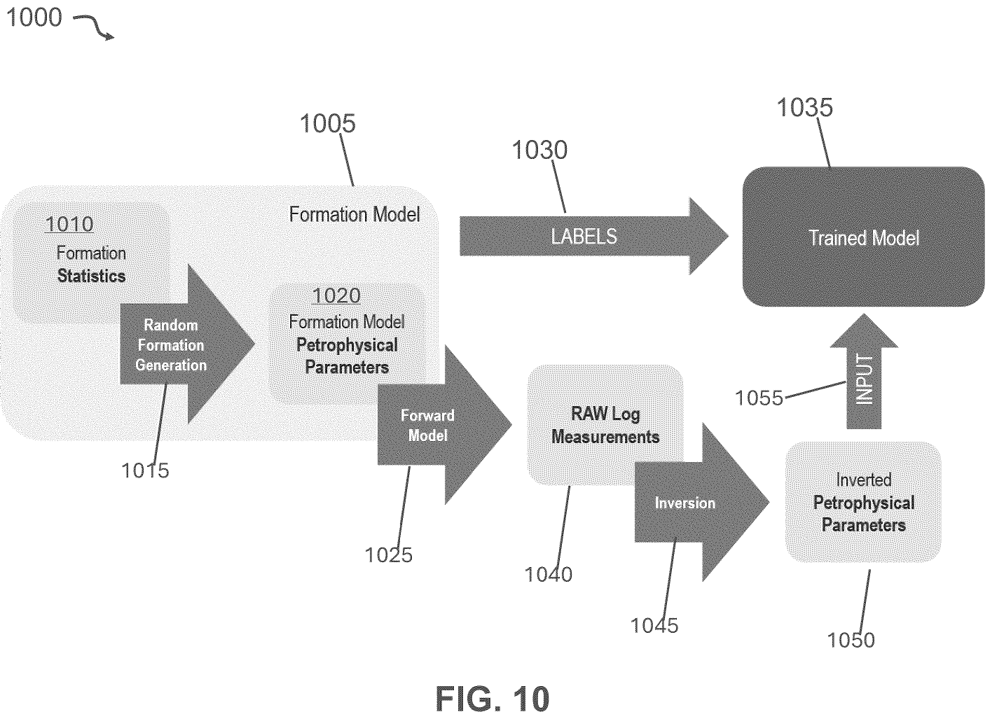

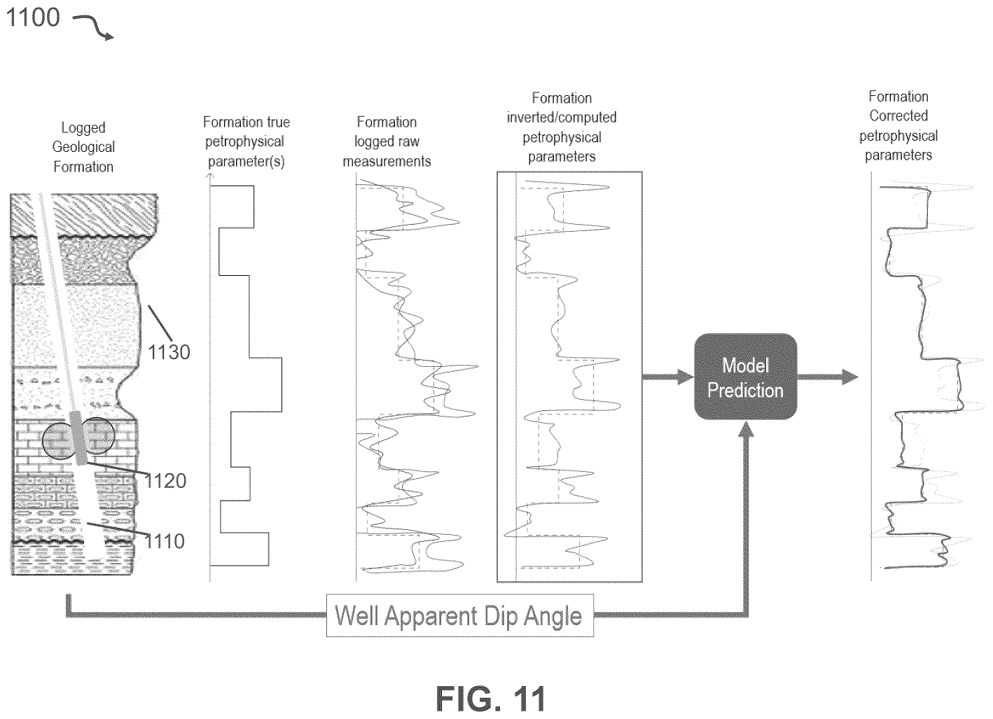

FIG. 10 is an example of a general workflow for database generation and model training. FIG. 11 is an example of a workflow for model application.

In an example workflow 1000 in FIG. 10, a geological formation model 1005 may include in input of geological formation statistics 1010 for a random geological formation generation model 1015 and geological formation model petrophysical parameters 1020 for a forward model 1025. The geological formation model 1105 may provide labels 1030 (e.g., geological and petrophysical features and parameters) to generate a trained model 1035. In addition, the forward model 1025 may be provided with raw log measurements 1040 for an inversion model 1045, which may be provided with inverted petrophysical parameters 1050 as an input 1055 to the trained model 1035.

In an example workflow 1100 in FIG. 11, for a well 1110 being logged with a tool 1120 in a geological formation 1130, one or more true petrophysical parameters may be obtained for the geological formation. Logged raw measurements may also be obtained for the geological formation. Inverted and/or computed petrophysical parameters may then be obtained for the geological formation. The true petrophysical parameters, logged raw measurements, and inverted and/or computed petrophysical parameters may then be input to a model prediction along with an apparent dip angle for the well. The model may then predict corrected petrophysical parameters for the well.

### III. Apparent Conductivity and Dielectric Constant for Coaxial Propagation Measurements

Consider an elemental coaxial propagation tool including of one transmitter and two receivers with the tool axis dipping at an angel of θ relative to the normal to the lamination planes in a homogeneous and transversely isotropic formation. The voltages induced in the two receivers are
[symbol] , (1)

where,
[symbol] , (2)

In the above, γ is anisotropy ratio, γ=\tilde{σ}ₕ/\tilde{σ}ᵥ. Here, \tilde{σ}ₕ and \tilde{σ}ᵥ are complex horizontal and vertical conductivity, respectively. The logarithm of the ratio of the two voltages can be written as
[symbol] , (3)

In arriving at the above equation, it has been presumed that the moments of two receivers are identical. Using the following three expansions, for example,
[symbol] , (4)
[symbol] , (5)
[symbol] , (6)

It can be shown that when the frequency is low, and, the third term on the right-hand side of Eq. (A3) can be expanded in terms of a polynomial of kₕL and kᵥL as
[symbol] , (7)

Substituting Equation 7 in Equation 3 yields
[symbol] , (8)

The complex apparent conductivity for a coaxial propagation tool is, where. According to Equation 8, when the frequency approaches zero, the following approximation holds,
[symbol] , (9)

The anisotropy ratio γ in Equation 2 is given by
[symbol] , (10)

Obviously, when the resistivity and dielectric constant share the same anisotropy ratio,
[symbol] , (11)

Apparent conductivity \tilde{σ}_{zz,a} can be written in component form as \tilde{σ}_{zz,a}≡\tilde{σ}ₐ−iωε₀ε_{r,a}, then,
[symbol] , (12a)
[symbol] , (12b)

Obviously,
[symbol] , (13a)
[symbol] , (13b)

Consider two cases of particular interest, e.g., when dip is 0 and 90°, respectively. Obviously, when, In other words, there may be no sensitivity to the vertical components of resistivity and dielectric constant when the well is vertical and perpendicular to the bedding planes.

On the other hand, when, That is, the apparent resistivity and dielectric constant may be sensitive to both of their horizontal and vertical components when the well is horizontal and parallel to the bedding planes.

### IV. Algorithms Description and Code Implementation

The implementation of example embodiments can be described as four separate stages:
1. Geological formation generation;
2. Modeling (e.g., forward model and inverse model);
3. Neural network training for dielectric 1D inversion enhancement; and
4. Neural network inference for dielectric 1D inversion enhancement (e.g., applying the trained network).

The code may be written in any appropriate coding language, and may utilize popular open-source libraries. In the subsequent sections, each stage is briefly described,

### A. Geological Formation Model Generation

A model of a geological formation may be generated by defining its descriptive parameters including number of layers, layers thicknesses, layer resistivities, and relative permittivity of each layer. Additionally, part of the formation generation may be the accessibility of the formation information, e.g., in form logs. In some examples, the formation model may be randomly generated or generated without reference to a particular real-world geological formation, e.g., using some predefined statistics.

A user may begin by defining, for example, a number of layers, lower and upper limits of dominant thicknesses, maximum layer thickness, thickness resolution (e.g., minimum thickness change between any two layers), and resistivity lower and upper limits. Table 3 below lists some parameters that may be used a formation generation algorithm.

TABLE 3

| Parameter | Value |
|---|---|
| Number of layers | 150 |
| Lower dominant thickness (ft.) | 1 |
| Upper dominant thickness (ft.) | 5 |
| Maximum thickness (ft.) | 20 |
| Thickness resolution (ft.) | 0.5 |
| Lower resistivity limit (Ω · m) | 0.2 |
| Upper resistivity limit (Ω · m) | 2000 |

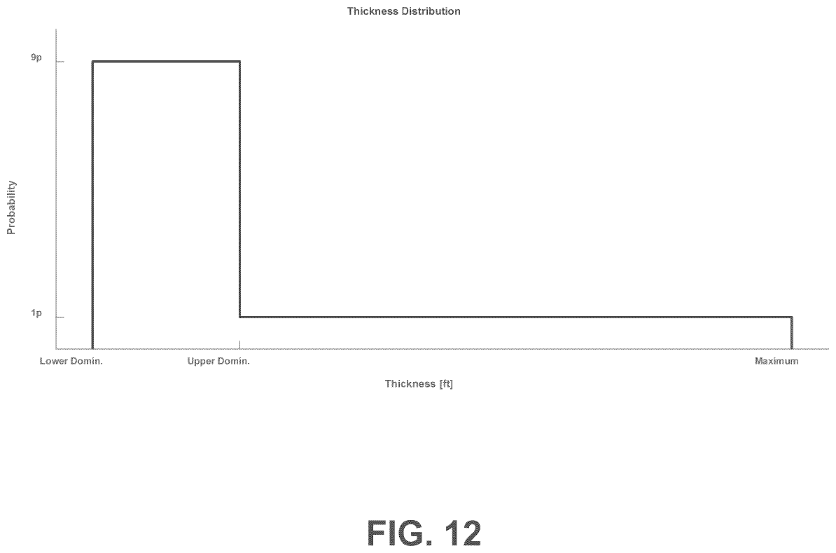

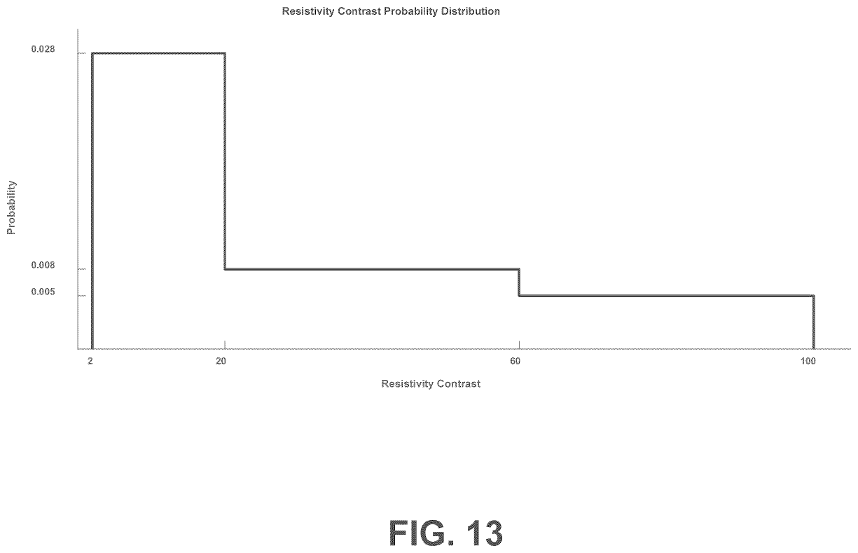

FIG. 12 is a graph of layer thickness probability distribution. FIG. 13 is a graph of resistivity contrast probability distribution.

Layer thicknesses may be randomly generated, for example, by independently withdrawing a thickness value from the probability distribution, as shown in FIG. 12. As illustrated in FIG. 12, the likelihood to have a thickness value in the dominant thickness range is nine times higher than getting value outside the range. The distribution emphasizes thickness values between the lower dominant and upper dominant limits.

Horizontal resistivities may be randomly generated. For example, first layer resistivity may be withdrawn from uniform distribution with continuous uniform distribution with a lower bound set to 2 ohm-meters (Ω·m) and an upper bound set to 100 Ω·m. For each subsequent layer, resistivity contrast may be withdrawn from the probability distribution in FIG. 13, for example, with the condition that associated resistivity does not exceed the predefined resistivity limits in Table 3, where the layer resistivity may be computed from the resistivity contrast and the previous layer's resistivity. If the condition is not met, a new resistivity contrast value may be withdrawn until the condition is met. As shown in the FIG. 13 example, the distribution may be provided such that there are three ranges (2, 20), (20, 6), and (60, 100), with corresponding probabilities equal to 50%, 30%, and 20%, respectively.

Lastly, horizontal relative permittivity may be computed from the resistivity using and εᵣ^{2MHz}=108.49 σ^{0.349} as shown in the examples of FIGS. 1 and 2. Once all the formation parameters are defined, logs can be generated for any given anisotropy and relative dip angle. The anisotropy may be used to compute the vertical resistivity and vertical relative permittivity while the relative dip angle is used to compute the measured depth, for example, preserving the true stratigraphic thickness (TST). Apparent resistivity and apparent relative permittivity are not computed here in this example, and may be left to be computed in the modeling stage, e.g., when computing apparent dielectric permittivity (ε_{r,a}) and apparent resistivity (Rₐ) in the FIG. 1 example.

Finally, logs may be generated. In an experiment, fifty different logs were generated by enumerating over ten different relative dip angles and five different anisotropy values. The selected angle and anisotropy values for this study are shown in Table 2. The logs may be prepared to be used as the input files for the forward model engine, for example, by appending a header to the log, making some minor shape format, and/or saving the log, e.g., as in a .prn file.

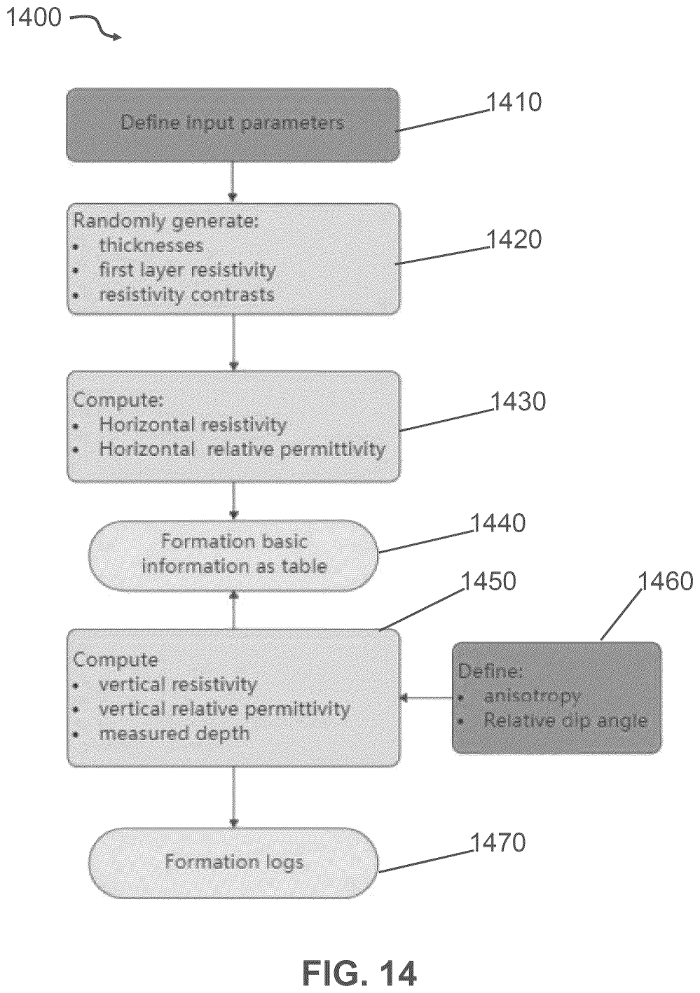

FIG. 14 is a flowchart of a geological formation model generation process according to an example embodiment of the present disclosure.

In FIG. 14, an example geological formation model generation process 1400 may include an operation 1410 to define input parameters. Next, the process 1400 may randomly generate thicknesses, first layer resistivity, and resistivity contrasts in operation 1420. The process 1400 may then compute horizontal resistivity and horizontal relative permittivity in operation 1430. In operation 1440, the process 1400 may provide basic information about the geological formation as a table. The operation 1440 may also be provided with computed values from another operation 1450, e.g., vertical resistivity, vertical relative permittivity, and measured depth. Definitions for anisotropy and relative dip angle may be provided in operation 1460 for the computation of operation 1450. Finally, logs for the geological formation model may be provided in operation 1470.

### B. Modeling

Given the formation logs, including the horizontal and vertical resistivity and relative permittivity, and the tool information, the forward model may simulate the attenuation and phase-shift curve set (AT/PS). Subsequently, the inverse model engine may take the forward model outputs, and may estimate the apparent resistivity and apparent relative permittivity logs. While this stage may be straightforward, it may be time-consuming and may require close attention by the user. In the experiment, there were 200 different cases to be run, so it was helpful to create an efficient workflow. For example, the process may be automated by creating a script that automatically formats the input files in the desired form, runs the model, and saves the output files appropriately.

### C. Neural Network Training

Neural networks (NN) are powerful and practical machine-learning algorithms used in many applications. Frequently asked questions include (1) what NN architecture to choose, (2) how to structure the data, and (3) how to optimize the NN design while training. As is evident by the recent achievements of large language models (LLMs), a good NN architecture combined with good data can have remarkable results. Once an optimum NN architecture is determined and the data structure is chosen, the rest of the process may become clear and straightforward.

For relative permittivity enhancement, different NN architectures were investigated, where each proposed architecture was optimized for the given problem. Eventually, convolutional neural network (CNN) architecture was selected by experimental results. CNN outperformed other NN architecture for sequence modeling, e.g., recurrent networks. Well logs are an example of sequence modeling as each log includes consecutive measurements of the same variable. As a use case in the oil and gas industry, a CNN model was developed to predict missing sonic and bulk density logs from gamma ray logs and other drilling information. The experimental implementation of the CNN was adapted from a known temporal convolutional network (TCN), and used hyperparameters listed in Table 4. Table 4 shows relative permittivity enhancement CNN hyperparameters.

TABLE 4

| Hyperparameter | Value |
|---|---|
| Number of layers | 2 |
| Number of features | 3 |
| Number of filters | 64 |
| Kernel size (filter width) | 3 |
| Number of Stacks | 5 |
| Dilation | Vector of ones |
| Padding | ‘same’ |
| Use skip connections | True |
| Dropout rate | 0.0 |
| Return sequence | True |
| Activation | ‘relu’ |
| Kernel initializer | ‘he_normal’ |
| Use batch norm | False |
| Use layer norm | True |
| Use weight norm | False |

In an example used in some experimental results, a “dense” layer followed the TCN layers with activation set to “sigmoid” to project the results to the desired output shape. The CNN may include, for example, an input layer, repeating hidden layer sets, and an output layer. Each of the repeating layer sets may include, for example, a normalization layer, a convolutional layer, and a rectified linear unit. In the example shown in FIG. 5, the repeating layer sets is illustrated as being repeated 5 times (×5). Also in the FIG. 5 example, 8 kernels are illustrated (k=8) in the convolutional layers. Embodiments are not limited thereto.

When it comes to the data, all synthetic logs may be read and stacked over each other, for example, to form one matrix. In one example, only three logs may be extracted to be used as input Apparent Resistivity (Rapp), Apparent Relative Permittivity (EPSlapp), relative dip angle (Inc). This may make the input data have the form of two-dimensional (2D) matrix with three columns (e.g., the extracted three logs) and N rows, where N is a total number of measurements from all combined input logs (e.g., 200 files in the experimental case). Embodiments are not limited to these numbers.

The input matrix may be split into smaller 2D matrices, for example, with a window size set to 128 and slide step set at be 16. As such, there may be overlap among the sub-matrices. The 3×128 sub-matrices may be used as the input units to the CNN. The sub-matrices may be structured as a three-dimensional (3D) matrix, for example, in the code 3×128×K. However, in one example, only one sub-matrix may be processed at a time. Alternatively, multiple sub-matrices may be processed substantially simultaneously and/or in parallel. Finally, the data may be scaled, e.g., from 0 to 1, for example, using Min-Max scaling, then may be split into training and validation datasets, e.g., using a randomized 80:20 split.

The model trained on the synthetic data described above using the hyperparameters listed in Table 5. Table 6 shows examples of 2D matrix CNN hyperparameters.

| Hyperparameter | Value |
|---|---|
| Loss | Mean-Square Error |
| Score | R2 score |
| Learning rate | 2e−4 |
| Batch size | 16 |
| Number of epochs | 500 |

Once the CNN model is fitted, the model weights may be saved, for example, along with the scaling factors from the Min-Max scaling to be used in the inference stage. The exact model architecture may be used in an inference step.

### D. Neural Network Inference

The fourth stage may be to apply the relative permittivity enhancement on new datasets to evaluate its performance. For this, the popular Oklahoma model as used in experiments. The associated model logs were generated using the same forward and inverse models. The same NN architecture may be set-up, and the weights may be loaded. One advantage of the CNN is that it can take an input of any arbitrary length. Therefore, the input may be structured as 2D matrix with three columns: the apparent resistivity, the apparent relative permittivity, and the relative dip angle with length corresponding to the Oklahoma log length. Basic preprocessing may be applied on the 2D matrix, for example, including the Min-Max scaling using the same scaling factors from the training stage. The matrix may be fed to the NN to infer (or predict) the enhanced relative permittivity. A simple smoothing algorithm, such as moving average, may be used to clean the final output, for example, for high dip angles with high anisotropy. Finally, the output may be evaluated visually, for example, by plotting the results in log-like plot and quantitatively, e.g., using root-mean-squared error (RMSE) and coefficient of determination (R squared).

Dielectric enhancement modeling may leverage the forward/inversion modeling capability. It may be designed to correct the EPSI inverted artifacts occurring at extreme relative dip angles and anisotropy. The formation model may be generated with random layers parameters that may be focused within a certain statistical range. The model may learn from the initial formation model layer. Once there are enough random layers there may be no more need for a model update. The method may not be based on physical laws, and the model may be applied even while drilling and in any drilling condition that may be covered within the generated geological formation model.

In one example, the enhanced dielectric log can be used to predict water volume (e.g., bulk volume of water (BVW)) in complex (e.g., variable salinity) and extreme (e.g., high relative dip angles and complex geological formation) conditions, even while drilling, as the model does not require intervention of a human interpreter.

Systems and methods are described that allow petrophysical measurements with forward and inversion modeling capabilities (e.g., dielectric constant in the described example) to be used even when extreme apparent dip angle and anisotropy (and other factors) artifacts completely obliterate the information in the log curve.

A 2D deconvolution supervised model has been developed to improve the inversion results with the goal of eliminating or drastically reducing artifacts and improving accuracy at high relative formation angles (e.g., >85°) and in the presence of high anisotropy. Spikes and artifacts in the inverted relative permittivity may be removed by developing a 2D deconvolution neural network model.

To achieve such results, the forward model may be used to generate attenuation and phase shift logs from a complex formation model at different relative angles and anisotropy values. Those logs may be inverted, and the resulting dielectric constant may be labelled versus the input formation model, along with relative angle and anisotropy value. The model may be tested on Oklahoma model as first validation steps. Formation model apparent resistivity and relative permittivity may be generated starting from horizontal resistivity.

A trained model according to example embodiments of the present disclosure may be used, for example, for early petrophysical planning and/or assessment. For example, it may help determine and/or visualize where layers change within a target geological formation and/or whether a drilling/logging tool may be going out of its planned path. For example, outputs of a model trained according to example embodiments may be used to adjust operation of a downhole tool during operation of the tool, e.g., to stay within or close to its planned path in a target geological formation. As another example, outputs of a model trained according to example embodiments may be used to plan and start a logging/drilling operation within a target geological formation.

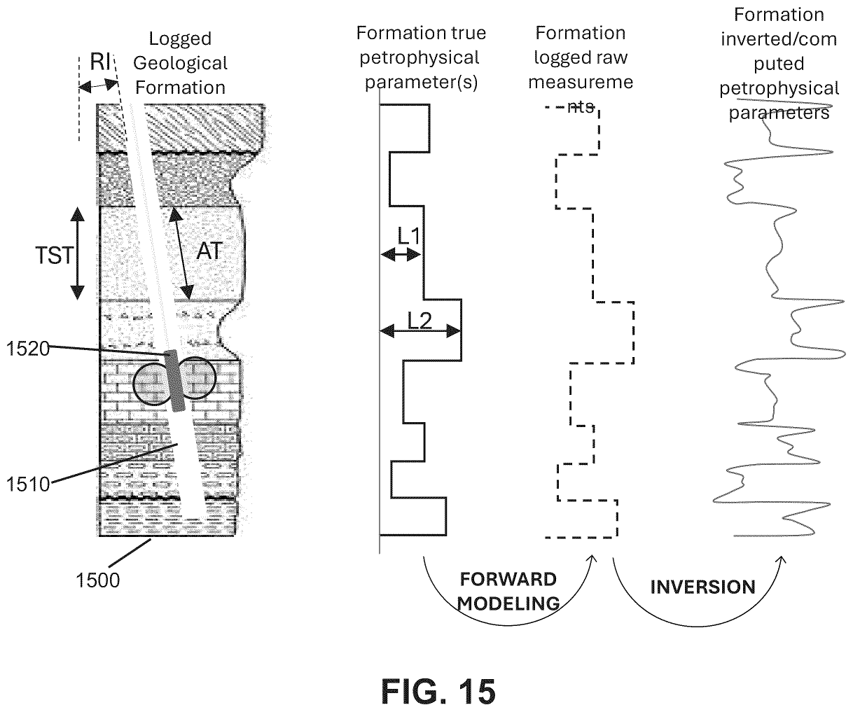

FIG. 15 is a cross section of a geological formation with a well and tool and measurements and parameters for the geological formation.

FIG. 15 shows an example of a geological formation 1500 with a well 1510 and tool 1520 in the well 1510. In FIG. 15, “RI” is the relative inclination of the well 1510 with respect to the layers of the geological formation 1500. In the example, RI is 0 (e.g., 0°) when the well is perpendicular to the formation layers and 90 (e.g., 90°) when the well is parallel to the layer. Measurements degrade with the increase of the angle. The relative inclination may also cause the layer thickness as observed inside the well (“AT”) to appear to be greater than the effective layer thickness (TST). A parameter that may affect the results and measurements, besides the petrophysical value (which may be, for example, too low or too high) is the measurement contrast between the layers. Inter layer contrast (IC) is the ratio between petrophysical parameters of two layers (L1/L2), where L1 is a petrophysical value of a first layer and L2 is a petrophysical value of a second layer.

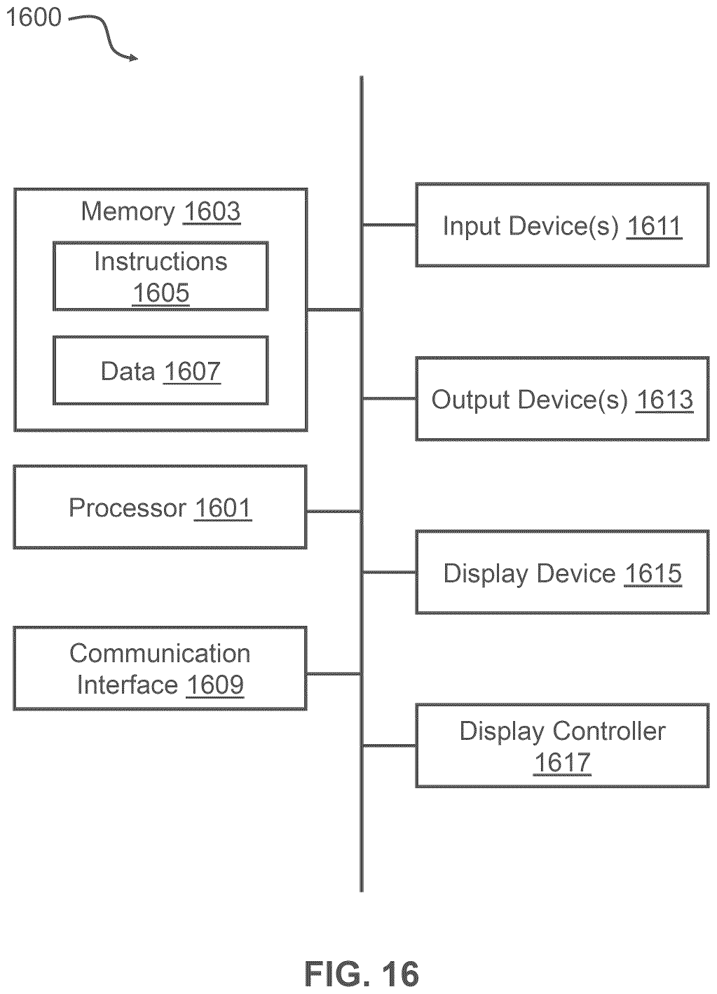

FIG. 16 illustrates certain components that may be included within a computer system according to an example embodiment of the present disclosure.

FIG. 16 illustrates certain components that may be included within a computer system 1600, which may be used to control features according to embodiments of the present disclosure, such as the features discussed with reference to FIGS. 1-14. One or more computer systems 1600 may be used to implement the various devices, components, and systems described herein.

The computer system 1600 includes a processor 1601. The processor 1601 may be a single processor or may include multiple processors and/or sub-processors. The processor 1601 may be a general-purpose single-or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 1601 may be referred to as a central processing unit (CPU). Although just a single processor 1601 is shown in the computer system 1600 of FIG. 16, in an alternative configuration, a combination of processors (e.g., an ARM and DSP) could be used. In one or more embodiments, the computer system 1600 further includes one or more graphics processing units (GPUs), which can provide processing services related to both entity classification and graph generation.

The computer system 1600 also includes memory 1603 in electronic communication with the processor 1601. The memory 1603 may be any electronic component capable of storing electronic information. For example, the memory 1603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 1605 and data 1607 may be stored in the memory 1603. The instructions 1605 may be executable by the processor 1601 to implement some or all of the functionality disclosed herein. Executing the instructions 1605 may involve the use of the data 1607 that is stored in the memory 1603. Any of the various examples of modules and components described herein may be implemented, partially or wholly, as instructions 1605 stored in memory 1603 and executed by the processor 1601. Any of the various examples of data described herein may be among the data 1607 that is stored in memory 1603 and used during execution of the instructions 1605 by the processor 1601.

A computer system 1600 may also include one or more communication interfaces 1609 for communicating with other electronic devices. The communication interface(s) 1609 may be based on wired communication technology, wireless communication technology, or both. Some examples of communication interfaces 1609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1600 may also include one or more input devices 1611 and one or more output devices 1613. Some examples of input devices 1611 include a keyboard, mouse, microphone, remote control device, button, joystick, trackball, touchpad, and lightpen. Some examples of output devices 1613 include a speaker and a printer. One specific type of output device that is typically included in a computer system 1600 is a display device 1615. Display devices 1615 used with embodiments disclosed herein may utilize any suitable image projection technology, such as liquid crystal display (LCD), light-emitting diode (LED), gas plasma, electroluminescence, or the like. A display controller 1617 may also be provided, for converting data 1607 stored in the memory 1603 into text, graphics, and/or moving images (as appropriate) shown on the display device 1615.

The various components of the computer system 1600 may be coupled together by one or more buses, which may include a power bus, a control signal bus, a status signal bus, a data bus, etc. For the sake of clarity, the various buses are illustrated in FIG. 16 as a bus system 1619.

Following are sections in accordance with at least one embodiment of the present disclosure:

Clause 1: A method, including: generating a synthetic geological formation model of a synthetic geological formation, including: receiving values for: layer thicknesses for each layer of the synthetic geological formation, resistivity contrast for each layer of the synthetic geological formation, horizontal resistivity, resistivity anisotropy, and relative dip angle, determining a dielectric assumption, determining a horizontal relative permittivity based on the dielectric assumption and the resistivity anisotropy, determining a vertical relative permittivity based on the resistivity anisotropy, determining a vertical resistivity based on the horizontal resistivity, and determining, for each layer of the synthetic geological formation, a respective apparent dielectric permittivity value and a respective apparent resistivity value based on the horizontal resistivity, the horizontal relative permittivity, the vertical relative permittivity, and the vertical resistivity, performing one-dimensional (1D) inversion for resistivity and permittivity, including: generating random geological layer parameters based on a statistical distribution, generating a final reference formation model by inputting the random geological layer parameters to the synthetic geological formation model, performing forward modeling of the synthetic geological formation model, generating attenuation and phase-shift logs from the forward modeling, generating a 1D inversion model from the attenuation and phase-shift logs, and generating an inverted resistivity value and an inverted permittivity value, training a dielectric enhancement model, including: validating the dielectric enhancement model with the apparent dielectric permittivity values and the apparent resistivity values of the synthetic geological formation model and an enhanced inverted permittivity value, training a convolutional neural network with the inverted resistivity value, the inverted permittivity value, and the relative dip angle, and updating the enhanced inverted permittivity value with an output of the convolutional neural network when the validating the dielectric enhancement model fails, generating a model prediction for layers of a target geological formation, including: inputting the inverted resistivity value, the inverted permittivity value, and the relative dip angle to the trained and validated dielectric enhancement model to further update the enhanced inverted permittivity value, and identifying respective layers of a target geological formation, including: receiving logged values for the target geological formation including at least: layer thicknesses for each layer of the target geological formation, resistivity contrast for each layer of the target geological formation, horizontal resistivity, resistivity anisotropy, and relative dip angle, and correcting the logged values for the target geological formation by inputting the logged values into the trained dielectric enhancement model and outputting corrected petrophysical parameters for the target geological formation.

Clause 2: The method of clause 1, wherein the convolutional neural network includes: an input layer, a plurality of repeating hidden layer sets, each of the plurality of repeating hidden layer sets including: a normalization layer, a convolutional layer, and a rectified linear unit, and an output layer.

Clause 3: The method of clause 2, wherein the plurality of repeating hidden layer sets is repeated 5 times.

Clause 4: The method of clause 1, wherein: the values for: layer thicknesses for each layer of the synthetic geological formation, resistivity contrast for each layer of the synthetic geological formation, horizontal resistivity, resistivity anisotropy, and relative dip angle are provided as an input matrix, the input matrix is split into a plurality of sub-matrices and input into the convolutional neural network, and an output of the convolutional neural network is scaled and split into training and validation datasets.

Clause 5: The method of clause 1, further including predicting a bulk volume of water (BVW) for the target geological formation, including: receiving neutron porosity and gamma ray values for the target geological formation, and correcting the logged values and the neutron porosity and gamma ray values for the target geological formation with the trained dielectric enhancement model and outputting the BVW for the target geological formation.

Clause 6: The method of clause 1, further including performing a blind test on a known model layer sequence to evaluate the model prediction.

Clause 7: The method of clause 1, further including displaying a comparison of the corrected logged values and the received logged values.

Clause 8: The method of clause 1, wherein: the corrected petrophysical parameters include a corrected dielectric permittivity value, and the method further includes: measuring a dielectric permittivity value for a target geological formation with a downhole tool operating in the target geological formation, comparing the measured dielectric permittivity value to the corrected dielectric permittivity value, determining that the downhole tool is not on a target path based on a result of the comparing, and changing a path of the downhole tool to match the target path.

Clause 9: A system, including: one or more processors, and a non-transitory computer-readable medium storing instructions that, when executed, cause the one or more processors to: generate a synthetic geological formation model of a synthetic geological formation, including: receiving values for: layer thicknesses for each layer of the synthetic geological formation, resistivity contrast for each layer of the synthetic geological formation, horizontal resistivity, resistivity anisotropy, and relative dip angle, determining a dielectric assumption, determining a horizontal relative permittivity based on the dielectric assumption and the resistivity anisotropy, determining a vertical relative permittivity based on the resistivity anisotropy, determining a vertical resistivity based on the horizontal resistivity, and determining, for each layer of the synthetic geological formation, a respective apparent dielectric permittivity value and a respective apparent resistivity value based on the horizontal resistivity, the horizontal relative permittivity, the vertical relative permittivity, and the vertical resistivity, perform one-dimensional (1D) inversion for resistivity and permittivity, including: generating random geological layer parameters based on a statistical distribution, generating a final reference formation model by inputting the random geological layer parameters to the synthetic geological formation model, performing forward modeling of the synthetic geological formation model, generating attenuation and phase-shift logs from the forward modeling, generating a 1D inversion model from the attenuation and phase-shift logs, and generate an inverted resistivity value and an inverted permittivity value, train a dielectric enhancement model, including: validating the dielectric enhancement model with the apparent dielectric permittivity values and the apparent resistivity values of the synthetic geological formation model and an enhanced inverted permittivity value, training a convolutional neural network with the inverted resistivity value, the inverted permittivity value, and the relative dip angle, and updating the enhanced inverted permittivity value with an output of the convolutional neural network when the validating the dielectric enhancement model fails, generate a model prediction for layers of a target geological formation, including: inputting the inverted resistivity value, the inverted permittivity value, and the relative dip angle to the trained and validated dielectric enhancement model to further update the enhanced inverted permittivity value, and identify respective layers of a target geological formation, including: receiving logged values for the target geological formation including at least: layer thicknesses for each layer of the target geological formation, resistivity contrast for each layer of the target geological formation, horizontal resistivity, resistivity anisotropy, and relative dip angle, and correcting the logged values for the target geological formation by inputting the logged values into the trained dielectric enhancement model and outputting corrected petrophysical parameters for the target geological formation.

Clause 10: The system of clause 9, wherein the convolutional neural network includes: an input layer, a plurality of repeating hidden layer sets, each of the plurality of repeating hidden layer sets including: a normalization layer, a convolutional layer, and a rectified linear unit, and an output layer.

Clause 11: The system of clause 10, wherein the plurality of repeating hidden layer sets is repeated 5 times.

Clause 12: The system of clause 9, wherein: the values for: layer thicknesses for each layer of the synthetic geological formation, resistivity contrast for each layer of the synthetic geological formation, horizontal resistivity, resistivity anisotropy, and relative dip angle are provided as an input matrix, the input matrix is split into a plurality of sub-matrices and input into the convolutional neural network, and an output of the convolutional neural network is scaled and split into training and validation datasets.

Clause 13: The system of clause 9, wherein the instructions further cause the one or more processors to predict a bulk volume of water (BVW) for the target geological formation, including: receiving neutron porosity and gamma ray values for the target geological formation, and correcting the logged values and the neutron porosity and gamma ray values for the target geological formation with the trained dielectric enhancement model and outputting the BVW for the target geological formation.

Clause 14: The system of clause 9, wherein the instructions further cause the one or more processors to perform a blind test on a known model layer sequence to evaluate the model prediction.

Clause 15: The system of clause 9, wherein the instructions further cause the one or more processors to display a comparison of the corrected logged values and the received logged values.

Clause 16: The system of clause 9, wherein: the corrected petrophysical parameters include a corrected dielectric permittivity value, and the instructions further cause the one or more processors to: measure a dielectric permittivity value for a target geological formation with a downhole tool operating in the target geological formation, compare the measured dielectric permittivity value to the corrected dielectric permittivity value, determine that the downhole tool is not on a target path based on a result of the comparing, and change a path of the downhole tool to match the target path.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure. In general, the particular numbers and variable values used in achieving the experiments and experimental results described herein are nonlimiting examples.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
generating a synthetic geological formation model of a synthetic geological formation, comprising:
receiving values for: layer thicknesses for each layer of the synthetic geological formation, resistivity contrast for each layer of the synthetic geological formation, horizontal resistivity, resistivity anisotropy, and relative dip angle;
determining a dielectric assumption;
determining a horizontal relative permittivity based on the dielectric assumption and the resistivity anisotropy;
determining a vertical relative permittivity based on the resistivity anisotropy;
determining a vertical resistivity based on the horizontal resistivity; and
determining, for each layer of the synthetic geological formation, a respective apparent dielectric permittivity value and a respective apparent resistivity value based on the horizontal resistivity, the horizontal relative permittivity, the vertical relative permittivity, and the vertical resistivity;
performing one-dimensional (1D) inversion for resistivity and permittivity, comprising:
generating random geological layer parameters based on a statistical distribution;
generating a final reference formation model by inputting the random geological layer parameters to the synthetic geological formation model;
performing forward modeling of the synthetic geological formation model;
generating attenuation and phase-shift logs from the forward modeling;
generating a 1D inversion model from the attenuation and phase-shift logs; and
generating an inverted resistivity value and an inverted permittivity value;
training a dielectric enhancement model, comprising:
validating the dielectric enhancement model with the apparent dielectric permittivity values and the apparent resistivity values of the synthetic geological formation model and an enhanced inverted permittivity value;
training a convolutional neural network with the inverted resistivity value, the inverted permittivity value, and the relative dip angle; and
updating the enhanced inverted permittivity value with an output of the convolutional neural network when the validating the dielectric enhancement model fails;
generating a model prediction for layers of a target geological formation, comprising:
inputting the inverted resistivity value, the inverted permittivity value, and the relative dip angle to the trained and validated dielectric enhancement model to further update the enhanced inverted permittivity value; and
identifying respective layers of a target geological formation, comprising:
receiving logged values for the target geological formation comprising at least:
layer thicknesses for each layer of the target geological formation, resistivity contrast for each layer of the target geological formation, horizontal resistivity, resistivity anisotropy, and relative dip angle; and
correcting the logged values for the target geological formation by inputting the logged values into the trained dielectric enhancement model and outputting corrected petrophysical parameters for the target geological formation.

2. The method of claim 1, wherein the convolutional neural network comprises:
an input layer;
a plurality of repeating hidden layer sets, each of the plurality of repeating hidden layer sets comprising:
a normalization layer;
a convolutional layer; and
a rectified linear unit; and
an output layer.

3. The method of claim 2, wherein the plurality of repeating hidden layer sets is repeated 5 times.

4. The method of claim 1, wherein:
the values for: layer thicknesses for each layer of the synthetic geological formation, resistivity contrast for each layer of the synthetic geological formation, horizontal resistivity, resistivity anisotropy, and relative dip angle are provided as an input matrix;
the input matrix is split into a plurality of sub-matrices and input into the convolutional neural network; and
an output of the convolutional neural network is scaled and split into training and validation datasets.

5. The method of claim 1, further comprising predicting a bulk volume of water (BVW) for the target geological formation, comprising:
receiving neutron porosity and gamma ray values for the target geological formation; and
correcting the logged values and the neutron porosity and gamma ray values for the target geological formation with the trained dielectric enhancement model and outputting the BVW for the target geological formation.

6. The method of claim 1, further comprising performing a blind test on a known model layer sequence to evaluate the model prediction.

7. The method of claim 1, further comprising displaying a comparison of the corrected logged values and the received logged values.

8. The method of claim 1, wherein:
the corrected petrophysical parameters include a corrected dielectric permittivity value; and
the method further comprises:
measuring a dielectric permittivity value for a target geological formation with a downhole tool operating in the target geological formation;
comparing the measured dielectric permittivity value to the corrected dielectric permittivity value;
determining that the downhole tool is not on a target path based on a result of the comparing; and
changing a path of the downhole tool to match the target path.

9. A system, comprising:
one or more processors; and
a non-transitory computer-readable medium storing instructions that, when executed, cause the one or more processors to:
generate a synthetic geological formation model of a synthetic geological formation, comprising:
receiving values for: layer thicknesses for each layer of the synthetic geological formation, resistivity contrast for each layer of the synthetic geological formation, horizontal resistivity, resistivity anisotropy, and relative dip angle;
determining a dielectric assumption;
determining a horizontal relative permittivity based on the dielectric assumption and the resistivity anisotropy;
determining a vertical relative permittivity based on the resistivity anisotropy;
determining a vertical resistivity based on the horizontal resistivity; and
determining, for each layer of the synthetic geological formation, a respective apparent dielectric permittivity value and a respective apparent resistivity value based on the horizontal resistivity, the horizontal relative permittivity, the vertical relative permittivity, and the vertical resistivity;
perform one-dimensional (1D) inversion for resistivity and permittivity, comprising:
generating random geological layer parameters based on a statistical distribution;
generating a final reference formation model by inputting the random geological layer parameters to the synthetic geological formation model;
performing forward modeling of the synthetic geological formation model;
generating attenuation and phase-shift logs from the forward modeling;
generating a 1D inversion model from the attenuation and phase-shift logs; and
generate an inverted resistivity value and an inverted permittivity value;
train a dielectric enhancement model, comprising:
validating the dielectric enhancement model with the apparent dielectric permittivity values and the apparent resistivity values of the synthetic geological formation model and an enhanced inverted permittivity value;
training a convolutional neural network with the inverted resistivity value, the inverted permittivity value, and the relative dip angle; and
updating the enhanced inverted permittivity value with an output of the convolutional neural network when the validating the dielectric enhancement model fails;
generate a model prediction for layers of a target geological formation, comprising:
inputting the inverted resistivity value, the inverted permittivity value, and the relative dip angle to the trained and validated dielectric enhancement model to further update the enhanced inverted permittivity value; and
identify respective layers of a target geological formation, comprising:
receiving logged values for the target geological formation comprising at least: layer thicknesses for each layer of the target geological formation, resistivity contrast for each layer of the target geological formation, horizontal resistivity, resistivity anisotropy, and relative dip angle; and
correcting the logged values for the target geological formation by inputting the logged values into the trained dielectric enhancement model and outputting corrected petrophysical parameters for the target geological formation.

10. The system of claim 9, wherein the convolutional neural network comprises:
an input layer;
a plurality of repeating hidden layer sets, each of the plurality of repeating hidden layer sets comprising:
a normalization layer;
a convolutional layer; and
a rectified linear unit; and
an output layer.

11. The system of claim 10, wherein the plurality of repeating hidden layer sets is repeated 5 times.

12. The system of claim 9, wherein:
the values for: layer thicknesses for each layer of the synthetic geological formation, resistivity contrast for each layer of the synthetic geological formation, horizontal resistivity, resistivity anisotropy, and relative dip angle are provided as an input matrix;
the input matrix is split into a plurality of sub-matrices and input into the convolutional neural network; and
an output of the convolutional neural network is scaled and split into training and validation datasets.

13. The system of claim 9, wherein the instructions further cause the one or more processors to predict a bulk volume of water (BVW) for the target geological formation, comprising:
receiving neutron porosity and gamma ray values for the target geological formation; and
correcting the logged values and the neutron porosity and gamma ray values for the target geological formation with the trained dielectric enhancement model and outputting the BVW for the target geological formation.

14. The system of claim 9, wherein the instructions further cause the one or more processors to perform a blind test on a known model layer sequence to evaluate the model prediction.

15. The system of claim 9, wherein the instructions further cause the one or more processors to display a comparison of the corrected logged values and the received logged values.

16. The system of claim 9, wherein:
the corrected petrophysical parameters include a corrected dielectric permittivity value; and
the instructions further cause the one or more processors to:
measure a dielectric permittivity value for a target geological formation with a downhole tool operating in the target geological formation;
compare the measured dielectric permittivity value to the corrected dielectric permittivity value;
determine that the downhole tool is not on a target path based on a result of the comparing; and
change a path of the downhole tool to match the target path.
